(19) United States
(12) Patent Application Publication
(10) Pub. No.: US 2017/0150203 A1
(43) Pub. Date: May 25, 2017

(54) METHOD, APPARATUS, MOBILE TERMINAL AND COMPUTER DEVICE FOR PREVIEWING MULTIMEDIA CONTENTS

(71) Applicants: Le Holdings (Beijing) Co., Ltd., Beijing (CN); LE SHI INTERNET INFORMATION & TECHNOLOGY CORP., BEIJING, Beijing (CN)

(72) Inventors: Yin LI, Beijing (CN); Zhinan ZHANG, Beijing (CN)

(73) Assignees: Le Holdings (Beijing) Co., Ltd., Beijing (CN); LE SHI INTERNET INFORMATION & TECHNOLOGY CORP., BEIJING, Beijing (CN)

(21) Appl. No.: 15/240,406

(22) Filed: Aug. 18, 2016

Related U.S. Application Data
(63) Continuation of application No. PCT/CN2016/083201, filed on May 24, 2016.

(30) Foreign Application Priority Data
Nov. 24, 2015 (CN) 201510824996.2

(51) Int. Cl. H04N 21/431; H04N 21/488; H04N 21/84

(52) U.S. Cl. CPC H04N 21/4312; H04N 21/84; H04N 21/4882

(57) ABSTRACT

The embodiments of the present disclosure provide a method, apparatus, mobile terminal and computer device for previewing multimedia contents. Wherein the method includes: detecting a first pressing operation on a multimedia list page by a user; in response to the first pressing operation, sending a server a previewing request message of an object operated by the first pressing operation, when the intensity of the detected first pressing operation is greater than a pressure threshold; and in response to the previewing request message, displaying previewing information of the object operated by the first pressing operation in a form of a floating window. According to the method, apparatus, mobile terminal and computer device for previewing multimedia contents provided by the embodiments of the present disclosure, previewing information of multimedia contents is displayed through a floating window for users, thereby saving data traffic and speeding up the previewing.

### CROSS REFERENCE TO RELATED APPLICATIONS

This application is a continuation of International Application No. PCT/CN2016/083201, filed on May 24, 2016, which claims the benefit of Chinese Patent Application No. 201510824996.2, filed on Nov. 24, 2015, both of which are hereby incorporated by reference in their entireties.

### TECHNICAL FIELD

The present disclosure relates to computer technology, more specially, to a method, apparatus, mobile terminal and computer device for previewing multimedia contents.

### BACKGROUND ART

With the continuous development of information technology and network technology, users have increased requirements for replaying multimedia. Currently, multimedia applications typically provide users with multimedia list pages, which include a plurality of images of multimedia contents. If the user needs to learn details of a single multimedia content, he/she selects the image corresponding to the multimedia content. After a terminal requests the multimedia content to a server and receives playback information of the multimedia content, the multimedia application switches to the details page of the multimedia content. If the user desires to learn details of other multimedia contents, then the application switches back to the multimedia list page, and repeats the above selection process. This brings inconvenient experience for users, and causes unnecessary data traffic at the same time.

### SUMMARY

The object of the present disclosure is to provide a method, apparatus, mobile terminal and computer device for previewing multimedia contents, so as to provide convenient and fast experience for users.

According to an aspect of the present disclosure, a method for previewing multimedia contents is provided. Wherein the method includes: detecting a first pressing operation on a multimedia list page by a user; in response to the first pressing operation, sending a server a previewing request message of the object operated by the first pressing operation, when the intensity of the detected first pressing operation is greater than a pressure threshold; and in response to the previewing request message, displaying previewing information of the object operated by the first pressing operation in a form of a floating window.

According to another aspect of the present disclosure, an apparatus for previewing multimedia contents is provided. Wherein the apparatus includes: an operation detection unit, configured to detect a first pressing operation on a multimedia list page by a user; a previewing request sending unit, configured to, in response to the first pressing operation, send a server a previewing request message of the object operated by the first pressing operation, when the intensity of the first pressing operation detected by the operation detection unit is greater than a pressure threshold; and a previewing information displaying unit, configured to, in response to the previewing request message, display previewing information of the object operated by the first pressing operation in a form of a floating window.

According to yet another aspect of the present disclosure, a mobile terminal is provided. Wherein the mobile terminal includes the above apparatus configured to preview multimedia contents.

According to yet another aspect of the present disclosure, a computer device is provided. Wherein the computer device includes: a memory, configured to store a program; a processor, configured to execute the program stored in the memory, wherein the program causes the processor to execute instructions of the above method for previewing multimedia contents.

According to yet another aspect of the present disclosure, a computer program is provided. Wherein the computer program includes computer readable code, a computer device executes instructions of the above method for previewing multimedia contents when the computer readable code is executed on the computer device.

According to yet another aspect of the present disclosure, a computer readable medium is provided. Wherein, the computer readable medium stores the above computer program.

According to the method, apparatus, mobile terminal and computer device for previewing multimedia contents provided by the embodiments of the present disclosure, previewing information of multimedia contents is displayed through a floating window for users, the amount of the data transmitted with the server is less, thereby saving data traffic and speeding up the previewing. Users can readily learn the previewing information of the multimedia contents through a multimedia list page, which is convenient and fast.

It is to be noted that the general descriptions above and the detailed descriptions that follow are merely exemplary and descriptive, and cannot limit the present disclosure.

### BRIEF DESCRIPTION OF THE DRAWINGS

For clarity of descriptions on the embodiments of the present disclosure, accompanying drawings used in descriptions on the embodiments are briefly introduced below. It is apparent that the accompanying drawings described below merely cover certain embodiments of the present disclosure and that those skilled in the art can obtain, without exerting creative efforts, other drawings from these accompanying drawings.

FIG. 1 is a flow chart illustrating a method for previewing multimedia contents according to a first embodiment of the present disclosure;

FIG. 2 is a flow chart illustrating a method for previewing multimedia contents according to a second embodiment of the present disclosure;

FIG. 3 is a structural diagram illustrating an apparatus for previewing multimedia contents according to a third embodiment of the present disclosure;

FIG. 4 is a structural diagram illustrating an apparatus for previewing multimedia contents according to a fourth embodiment of the present disclosure;

FIG. 5 is an exemplary schematic diagram illustrating a multimedia list page used in a method for previewing multimedia contents according to an embodiment of the present disclosure;

FIG. 6 is an exemplary schematic diagram illustrating a floating window used in a method for previewing multimedia contents according to an embodiment of the present disclosure;

FIG. 7 is a structural diagram illustrating a computer device according to a sixth embodiment of the present disclosure.

Particular embodiments of the present disclosure have been shown with reference to the above accompanying drawings, and more detailed descriptions will be given hereinafter. These accompanying drawings and literal descriptions are not intended to limit the scope of the present disclosure concepts by any means, but rather the present disclosure concepts are explained with reference to the particular embodiments for those skilled in the art.

### DETAILED DESCRIPTION OF THE EMBODIMENTS

Hereinafter, exemplary embodiments of the present disclosure are described in details with reference to the accompanying drawings.

### Embodiment 1

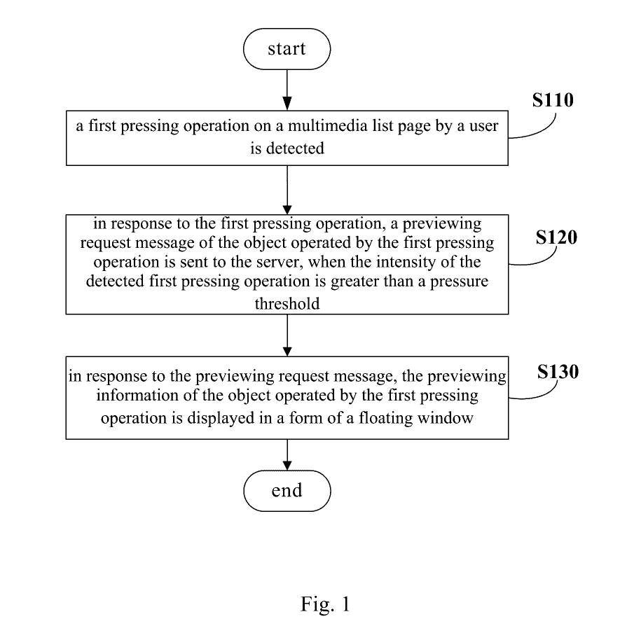

FIG. 1 is a flow chart illustrating a method for previewing multimedia contents according to a first embodiment of the present disclosure. Referring to FIG. 1, the method for previewing multimedia contents according to the embodiment of the present disclosure includes the following steps.

In step S110, a first pressing operation on a multimedia list page by a user is detected. Wherein, the multimedia content can be video and/or audio. The multimedia list page is a window provided by a mobile terminal for users to browse videos and/or audios. The mobile terminal may include but is not limited to mobile phones, tablet PCs and/or smart TV sets. Specifically, a variety of gesture operations may be operated on the mobile terminal, such as tap operation, light press operation, hard press operation and so on. For example, if a user wants to view a video and/or an audio content, he/she needs to click a replay button on the mobile terminal; a pressure sensor equipped in the mobile terminal may detect the tap operation of the user, and then the mobile terminal sends to a server a request message for replaying the video and/or the audio. In the present embodiment, the first pressing is a hard press operation. Compared with the tap operation, intensities of the hard press operations detected by the pressure sensor are different, and the request messages sent to the server are different as well.

In step S120, in response to the first pressing operation, a previewing request message of the object operated by the first pressing operation is sent to the server, when the intensity of the detected first pressing operation is greater than a pressure threshold. Specifically, a user performs the first pressing operation on the multimedia list page displayed by the mobile terminal, and the intensity (such as 5 Newtons) of the first pressing operation is greater than the pressure threshold. After the mobile terminal detects the first pressing operation, it may send a server a previewing request message of the object which is on the multimedia list page and is operated by the first pressing operation. For example, when browsing a multimedia list page of videos and/or audios, the user wants to view the introduction of a certain video and/or audio on the multimedia list page, the pressure sensor detects a hard press operation operated by the user, the mobile terminal sends the previewing request message of the video and/or the audio to the server.

In step S130, in response to the previewing request message, the previewing information of the object operated by the first pressing operation is displayed in a form of a floating window. Specifically, the server receives the previewing request message of the multimedia content, and then sends back the previewing information of the object operated by the first pressing operation to the mobile terminal. The mobile terminal receives the previewing information of the object operated by the first pressing operation and displays the previewing information in the form of a floating window. Optionally, with respect to the content details page of the video and/or the audio, the previewing information can be a brief introduction of the video and/or the audio. For example, the brief introduction can include but not be limited to the owner and/or the abstract of the multimedia content, and the creators/the performers of the video and/or the audio.

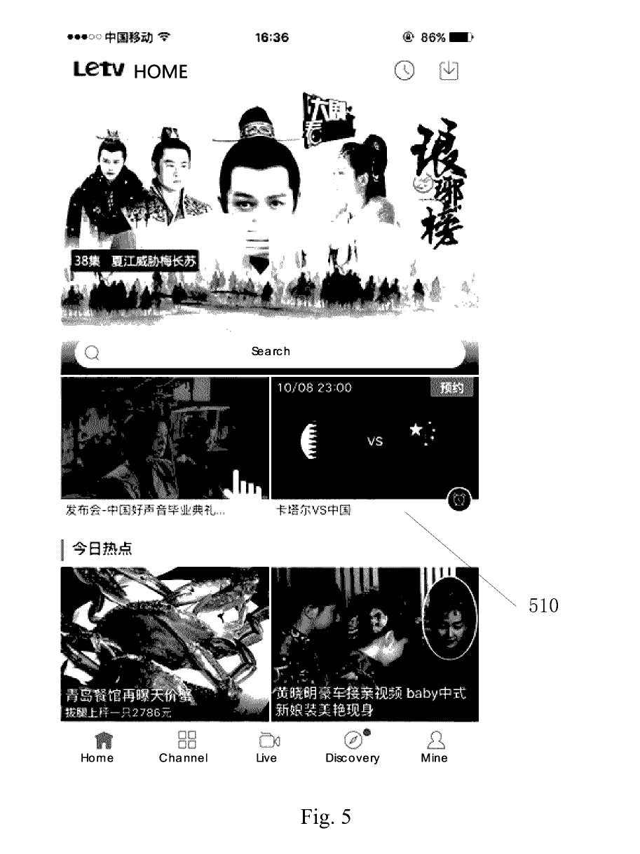

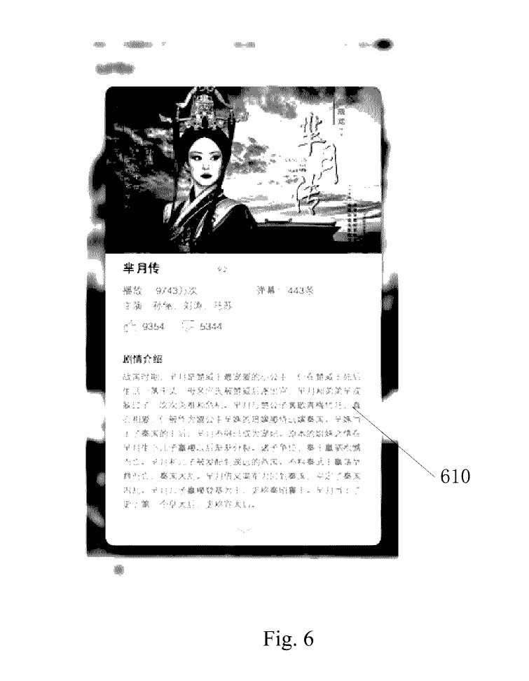

FIG. 5 is an exemplary schematic diagram illustrating a multimedia list page used in the method for previewing multimedia contents according to the embodiment of the present disclosure. FIG. 6 is an exemplary schematic diagram illustrating a floating window used in the method for previewing multimedia contents according to the embodiment of the present disclosure. Explanations are given with the multimedia being video as an example. The disclosure of the multimedia list page and the floating window will be described, and the principles of other disclosures are the same, which will be omitted herein. A user performs the first pressing operation on the multimedia list page 510 shown in FIG. 5. After a previewing request message is sent to the server and previewing information is received, the previewing information is displayed in the floating window 610 shown in FIG. 6. According to the method for previewing contents provided by the embodiment of the present disclosure, the previewing information of the multimedia contents is displayed through the floating window for users, the amount of the data transmitted with the server is less, thereby saving data traffic and speeding up the previewing. Users can readily learn the previewing information of the multimedia contents through the multimedia list page, which is convenient and fast.

### Embodiment 2

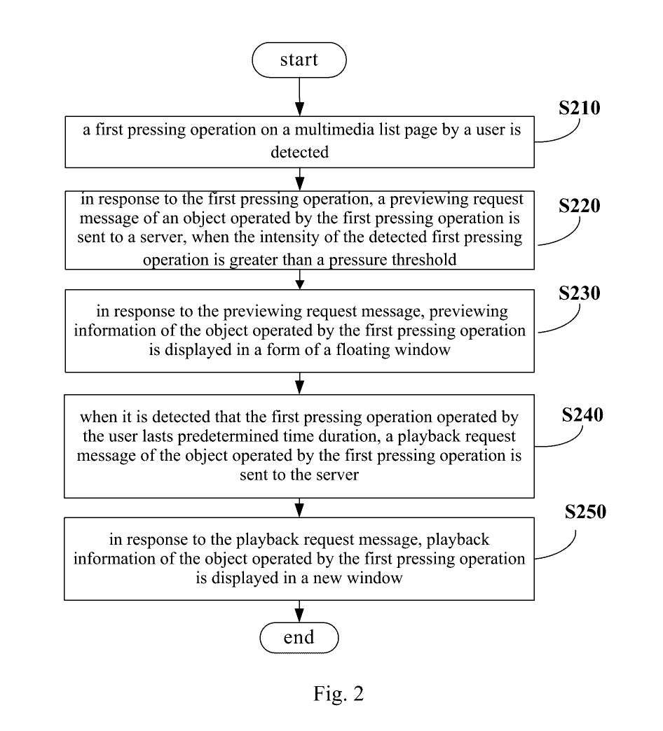

FIG. 2 is a flow chart illustrating a method for previewing multimedia contents according to a second embodiment of the present disclosure. Referring to FIG. 2, the method for previewing multimedia contents according to the present embodiment can be seen as a particular implementation of the method embodiment shown in FIG. 1. Specifically, the method can include the following steps.

In step S210, a first pressing operation on a multimedia list page by a user is detected.

In step S220, in response to the first pressing operation, a previewing request message of an object operated by the first pressing operation is sent to a server, when the intensity of the detected first pressing operation is greater than a pressure threshold.

In step S230, in response to the previewing request message, previewing information of the object operated by the first pressing operation is displayed in a form of a floating window.

Wherein, the contents of the step S210, the step S220 and the step S230 respectively correspond to those of the step S110, the step S120 and the step S130 in the above embodiment, and the functions and the principles of them are the same, which will be omitted herein. It should be noted, in the present embodiment, whether the floating window can be displayed continuously is based on whether the user's first pressing operation persists. If the first pressing operation persists, the floating window will be displayed continuously.

On the basis of the above steps, the method for previewing multimedia contents of the present embodiment can further include step S240 and step S250.

In step S240, when it is detected that the first pressing operation operated by the user lasts predetermined time duration, a playback request message of the object operated by the first pressing operation is sent to the server.

Specifically, when the time duration of the first pressing operation operated by the user on the multimedia list page shown in the mobile terminal lasts the predetermined time duration, the mobile terminal will send a playback request message of the object which is operated by the first pressing operation on the multimedia list page. In the present embodiment, the predetermined time duration can be set arbitrarily, such as 3 seconds or 5 seconds. For example, after browsing the brief introduction of the video and/or the audio in the floating window, if the user wants to view the video and/or the audio, the user can hard, long press the current page, and when the time duration lasts a predetermined time duration, the mobile terminal will send the playback request message of the video and/or the audio to the server.

In step S250, in response to the playback request message, playback information of the object operated by the first pressing operation is displayed in a new window.

Specifically, after the server receives the playback request message of the multimedia contents, the mobile terminal displays the playback information of the multimedia contents in a new window. For example, after receiving the playback request message of the video and/or the audio, the server informs the mobile terminal, which then will switch to the next window and enter into the playback content details page of the video and/or the audio. Then the user clicks the information of the playback content details page, and a certain segment of the video and/or the audio can be replayed.

Further, the above method can further include, in response to a release operation for the first pressing operation operated by the user, the floating window is closed. Specifically, the mobile terminal detects that the user stops the first pressing operation and determines that a release operation for the first pressing operation is received. Then the mobile terminal closes the floating window, and the user can continue to view the multimedia list page. For example, after opening the floating window to browse the previewing information of the video and/or the audio, the user releases the hard press operation, the pressure sensor senses the release operation and sends a command of closing the floating window to mobile terminal, then the mobile terminal closes the floating window, which avoids unnecessary traffic loss causing by the mobile terminal switching to the next window.

In the present embodiment, the time duration from the hard press operation to the release operation of the user cannot exceed predetermined time duration. Otherwise the mobile terminal will switch to the next window. Because users need to browse the contents in the floating window and the amount of the contents are different based on the different videos and/or audios, the predetermined time duration optionally can be different for videos and/or audios.

### Embodiment 3

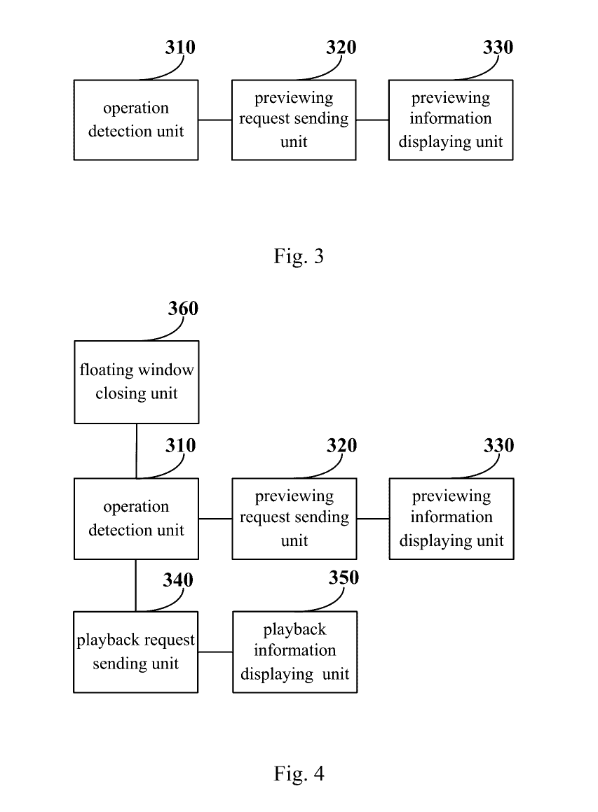

FIG. 3 is a structural diagram illustrating an apparatus for previewing multimedia contents according to a third embodiment of the present disclosure.

Referring to FIG. 3, in the present embodiment, the apparatus includes an operation detection unit 310, a previewing request sending unit 320 and a previewing information displaying unit 330.

The operation detection unit 310 is configured to detect a first pressing operation on a multimedia list page by a user.

Specifically, the multimedia includes video and/or audio. The first pressing operation preferably is a hard press operation.

The previewing request sending unit 320 is configured to, in response to the first pressing operation detected by the operation detection unit 310, send to a server a previewing request message of the object operated by the first pressing operation, when the intensity of the first pressing operation is greater than a pressure threshold.

The previewing information displaying unit 330 is configured to, in response to the previewing request message sent by the previewing request sending unit 320, display previewing information of the object operated by the first pressing operation in a form of a floating window.

### Embodiment 4

FIG. 4 is a structural diagram illustrating an apparatus for previewing multimedia contents according to a fourth embodiment of the present disclosure.

Referring to FIG. 4, in the present embodiment, besides the operation detection unit 310, the previewing request sending unit 320 and the previewing information displaying unit 330 in the above, the apparatus further includes a playback request sending unit 340, a playback information displaying unit 350 and a floating window closing unit 360.

The playback request sending unit 340 is configured to send the server a playback request message of the object operated by the first pressing operation, when the first pressing operation detected by the operation detection unit 310 lasts predetermined time duration.

Preferably, length of the predetermined time duration can be determined according to different videos and/or audios.

After the previewing information displaying unit 330 displays the floating window, the playback information displaying unit 350 is configured to respond to the playback request message sent by the playback request sending unit 340, and display playback information of the object operated by the first pressing operation in a new window.

After the previewing information displaying unit 330 displays the floating window, the floating window closing unit 360 is configured to, in response to a release operation for the first pressing operation detected by the operation detection unit 310, close the floating window.

Specifically, the time duration of the first pressing operation of the user cannot exceed the predetermined time duration.

### Embodiment 5

The embodiment of the present disclosure further provides a mobile terminal, wherein the mobile terminal includes the above apparatus for previewing multimedia contents.

Specifically, the mobile terminal can be a mobile phone, a tablet PC, or a smart TV set and so on.

Through the mobile terminal provided by the embodiment of the present disclosure, previewing information of multimedia contents is displayed through a floating window for users, the amount of the data transmitted with the server is less, thereby saving data traffic and speeding up the previewing. Users can readily learn the previewing information of the multimedia contents through a multimedia list page, which is convenient and fast.

### Embodiment 6

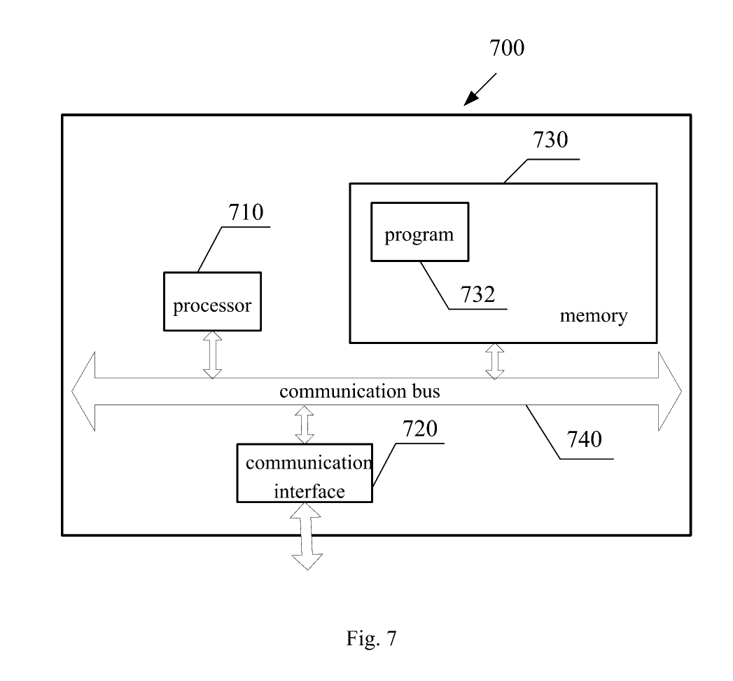

FIG. 7 is a structural diagram illustrating a computer device according to a sixth embodiment of the present disclosure. Particular embodiments of the present disclosure do not limit the specific embodying form of the computer device. Referring to FIG. 7, the computer device 700 may include: a processor 710, a communication interface 720, a memory 730 and a communication bus 740.

Herein, the processor 710, the communication interface 720 and the memory 730 perform communication with one another through the communication bus 740.

The communication interface 720 is adapted to communicate with other network units.

The processor 710 is adapted to execute a program 732, for performing corresponding steps described in the above embodiments for the method in particular.

Specifically, the program 732 can include program code, which includes computer executable instructions.

The processor 710 may be a central processing unit (CPU), or an Application Specific Integrated Circuit (ASIC), or one or more integrated circuits configured implementing the embodiments of the present disclosure.

The memory 730 is adapted to store the program 732. The memory 730 may contain a high speed RAM (randomly accessed memory) memory or may contain a non-volatile memory, such as at least one disk memory. The program 732 is specifically configured to enable the computer device 700 to perform the operations below: detecting a first pressing operation on a multimedia list page by a user; in response to the first pressing operation, sending a server a previewing request message of an object operated by the first pressing operation, when the intensity of the detected first pressing operation is greater than a pressure threshold; and in response to the previewing request message, displaying previewing information of the object operated by the first pressing operation in a form of a floating window.

In a particular embodying mode, the program 732 may also be configured to enable the computer device 700 to perform the operations below: in response to a release operation for the first pressing operation, closing the floating window.

In a particular embodying mode, the program 732 may also be configured to enable the computer device 700 to perform the operations below: sending the server a playback request message of the object operated by the first pressing operation, when the detected first pressing operation lasts a predetermined time duration; and in response to the playback request message, displaying playback information of the object operated by the first pressing operation in a new window.

Descriptions on corresponding steps and units in the above embodiments may be referred to for particular implementations of the operations performed in the program 732, and are not repeatedly described herein. Those skilled in the art can clear appreciate that for convenience and conciseness, the particular processing in the embodiment for the method can be referred to for the corresponding processing of the apparatus and modules described above, and is not repeatedly described herein.

In addition, the embodiments of the present disclosure also provide a computer program, which includes computer executable code. When the computer executable code is executed on the computer device, the computer device is caused to perform the method for previewing multimedia contents described in any one of the embodiments of the multiple methods described above.

Also, the embodiments of the present disclosure also provide a computer readable medium, on which the above computer program is stored.

Through the technical solutions provided in the embodiments of the present disclosure, previewing information of multimedia contents is displayed through a floating window for users, the amount of the data transmitted with the server is less, which saves the data traffic and accelerates the previewing speed. Users can directly know the previewing information of the multimedia contents through a list page of the multimedia, which is convenient and fast.

It is to be noted, various steps/components described in the present disclosure may be divided into more steps/components, two or more steps/components can be combined into new steps/components, or parts of steps/components can be combined into new steps/components, to achieve the goal of the present disclosure.

The above methods according to the present disclosure can be implemented in hardware or in firmware, or can be implemented as software or computer code stored in storage medium (such as CD ROM, RAM, floppy disk, hard disk, or magneto-optical disk), or can be implemented as computer code which will be store in local recording medium, and is downloaded through network and is originally stored in remote recording medium or in non-transitory machine-readable medium, thus the method described herein can be processed by the software stored in the recording medium used by general purpose computer, special purpose processors or a programmable hardware or dedicated hardware (such as ASIC or FPGA). It should be appreciated, computer, processor, microprocessor, controller or programmable hardware includes storage components (such as RAM, ROM, flash memory and etc.) which can store or receive software or computer code. When the software or the computer code is accessed and executed by the computer, the processor or the hardware, the processing methods described herein is implemented. In addition, when a general purpose computer accesses the code used to implement the process described herein, the execution of the code converts the general purpose computer into a special purpose computer for implementing the process described herein.

The above are merely particular embodying modes of the present disclosure, but the protection scope of the present disclosure is not limited thereto. Any one skilled in the art can readily conceive of changes or substitutions in the technical scope as disclosed in the present disclosure, which changes or substitutions should all fall in the protection scope of the present disclosure. Therefore, the protection range of the present disclosure should be determined only by the accompanying claims.

What is claimed is:

1. A method for previewing multimedia contents, comprising:
at an electronic device with a touch-sensitive display:
detecting a first pressing operation on a multimedia list page;
in response to the first pressing operation, sending a server a previewing request message of an object operated by the first pressing operation, when the intensity of the detected first pressing operation is greater than a pressure threshold; and
in response to the previewing request message, displaying previewing information of the object operated by the first pressing operation in a form of a floating window.

2. The method according to claim 1, wherein the method further comprises:
in response to a release operation for the first pressing operation, closing the floating window.

3. The method according to claim 2, wherein the method further comprises:
sending the server a playback request message of the object operated by the first pressing operation, when the detected first pressing operation lasts predetermined time duration; and
in response to the playback request message, displaying playback information of the object operated by the first pressing operation in a new window.

4. The method according to claim 2, wherein the multimedia comprises a video and/or an audio.

5. The method according to claim 1, wherein the method further comprises:
sending the server a playback request message of the object operated by the first pressing operation, when the detected first pressing operation lasts predetermined time duration; and
in response to the playback request message, displaying playback information of the object operated by the first pressing operation in a new window.

6. The method according to claim 1, wherein the multimedia comprises a video and/or an audio.

7. An apparatus for previewing multimedia contents, comprising:
an operation detection unit, configured to detect a first pressing operation on a multimedia list page;
a previewing request sending unit, configured to, in response to the first pressing operation, send a server a previewing request message of the object operated by the first pressing operation, when the intensity of the first pressing operation detected by the operation detection unit is greater than a pressure threshold; and
a previewing information displaying unit, configured to, in response to the previewing request message, display previewing information of the object operated by the first pressing operation in a form of a floating window.

8. The apparatus according to claim 7, wherein the apparatus further comprises:
a floating window closing unit, configured to, in response to a release operation for the first pressing operation detected by the operation detection unit, close the floating window.

9. The apparatus according to claim 8, wherein the apparatus further comprises:
a playback request sending unit, configured to send the server a playback request message of the object operated by the first pressing operation, when the first pressing operation detected by the operation detection unit lasts predetermined time duration; and
a playback information displaying unit, configured to respond to the playback request message, and display playback information of the object operated by the first pressing operation in a new window.

10. The apparatus according to claim 8, wherein the multimedia comprises a video and/or an audio.

11. The apparatus according to claim 7, wherein the apparatus further comprises:
a playback request sending unit, configured to send the server a playback request message of the object operated by the first pressing operation, when the first pressing operation detected by the operation detection unit lasts predetermined time duration; and
a playback information displaying unit, configured to respond to the playback request message, and display playback information of the object operated by the first pressing operation in a new window.

12. The apparatus according to claim 7, wherein the multimedia comprises a video and/or an audio.

13. A computer device, comprising:
a processor; and
a memory communicably connected with the processor and for storing instructions executable by the processor,
wherein execution of the instructions by the processor causes the processor to:
detect a first pressing operation on a multimedia list page; and
in response to the first pressing operation, send a server a previewing request message of an object operated by the first pressing operation, when the intensity of the detected first pressing operation is greater than a pressure threshold; and
in response to the previewing request message, display previewing information of the object operated by the first pressing operation in a form of a floating window.

14. The computer device according to claim 13, wherein the processor is further configured to:
in response to a release operation for the first pressing operation, close the floating window.

15. The computer device according to claim 14, wherein the processor is further configured to:
send the server a playback request message of the object operated by the first pressing operation, when the detected first pressing operation lasts predetermined time duration; and
in response to the playback request message, display playback information of the object operated by the first pressing operation in a new window.

16. The computer device according to claim 14, wherein the multimedia comprises a video and/or an audio.

17. The computer device according to claim 13, wherein the processor is further configured to:
send the server a playback request message of the object operated by the first pressing operation, when the detected first pressing operation lasts predetermined time duration; and
in response to the playback request message, display playback information of the object operated by the first pressing operation in a new window.

18. The computer device according to claim 13, wherein the multimedia comprises a video and/or an audio.
